(19) United States
(12) Patent Application Publication
(10) Pub. No.: US 2011/0100984 A1
(43) Pub. Date: May 5, 2011

(54) VINYL POUCH EQUIPPED WITH INTERNAL PRESSURE DISCHARGE UNIT USABLE IN MICROWAVE OVEN TO PREVENT CONTENTS FROM BEING LEAKED AND BEING DRIED

(75) Inventor: Yong-Kyo HAN, Seoul (KR)

(73) Assignee: Wonji Co., Ltd., Chungnam (KR)

(21) Appl. No.: 12/689,360

(22) Filed: Jan. 19, 2010

(30) Foreign Application Priority Data
Nov. 5, 2009 (KR) 10-2009-0106476

(51) Int. Cl. H05B 6/80; B65D 33/18; B65D 33/01

(52) U.S. Cl. 219/725; 383/211; 383/103

(57) ABSTRACT

Disclosed is a vinyl pouch usable in a microwave oven. The vinyl pouch fabricated using vinyl sheets in a multi-layer structure allows steam to be naturally emitted when contents in the vinyl pouch are heated in the microwave oven. The vinyl pouch prevents the contents from being leaked due to the explosion of the vinyl pouch caused by the expansion of the vinyl pouch. The vinyl pouch prevents the contents of the vinyl pouch from being dried. The vinyl pouch includes an upper sealing part and side sealing parts that are heat-sealed, a content retaining part having an open lower portion, and an internal pressure discharge unit comprising a sealing weak part open due to an internal pressure of the content retaining part, and a content holding part including an introduction line open due to opening of the sealing weak part and gas discharge lines above the sealing part.

### BACKGROUND OF THE INVENTION

1. Field of the Invention

The present invention relates to a vinyl pouch usable in a microwave oven, in which the vinyl pouch can be prevented from being explored or deformed when contents inside the vinyl pouch are heated in the microwave oven by employing an internal pressure discharge unit. More particularly, the present invention relates to a structure of an internal pressure discharge unit capable of preventing contents from being leaked out of a vinyl pouch and preventing the contents from being dried after the contents have been heated in a microwave oven.

2. Description of the Related Art

In general, a vinyl pouch is provided by facing two vinyl sheets having the same size with each other and sealing an upper portion and side portions of the vinyl sheets through thermal bonding for a predetermined width thereof. A lower portion of the vinyl pouch is provided in an open state such that contents such as foods are put into the vinyl pouch through the lower portion thereof. Thereafter, the lower portion of the vinyl pouch is sealed through thermal bonding, thereby keeping the contents while maintaining air tightness.

Therefore, such a vinyl pouch has been suitably used for packing instant foods adaptable for cooking in a microwave oven.

However, if the contents in the vinyl pouch are heated in the microwave oven, moisture is evaporated from the contents so that gas or steam is generated in the vinyl pouch. Thus, an internal pressure of the vinyl pouch is gradually increased, causing expansion of the vinyl pouch. In extreme case, the vinyl pouch may be exploded.

In this case, a user must adjust the internal pressure of the vinyl pouch by cutting away the upper portion of the vinyl pouch to open the vinyl pouch or making small pores in the vinyl pouch to discharge gas.

To solve the problems, vinyl pouches having internal pressure discharge units have been suggested. However, most of the internal pressure discharge units are mere gas discharge holes to discharge only gas such as steam. Accordingly, if a heating time is short, problems may not occur. If the heating time exceeds a desired time, a discharge amount of gas may be significantly increased. In addition, the contents may be rapidly boiled or the volume of the contents may be rapidly expanded due to the characteristics of the contents. In this case, the contents may be simultaneously discharged through the gas discharge hole.

Particularly, when the vinyl pouch is heated in the microwave oven, the vinyl pouch is laid down due to the structure thereof. In this case, the contents are leaked from the vinyl pouch to the microwave oven, so that the microwave oven becomes in a mess. The contents leaked from the vinyl pouch are contaminated, so that the contents must be disposed. In addition, the gas discharge hole may be clogged due to the contents leaked from the vinyl pouch.

Further, gas inside the vinyl pouch is discharged through the gas discharge hole, so that the moisture may be evaporated from the contents. Accordingly, after the contents have been heated, the contents may be dried and hardened to lose the original taste thereof.

### SUMMARY OF THE INVENTION

The present invention has been made to solve the above problems occurring in the prior art, and an object of the present invention is to provide a vinyl pouch usable in a microwave oven, capable of preventing contents thereof from being leaked and minimizing the evaporation of moisture from the contents even if the contents are heated beyond a desired time by employing an internal pressure adjusting unit.

In order to accomplish the above object, according to the present invention, an upper sealing part of a vinyl pouch includes a sealing weak part open due to the expansion of a content retaining part caused by an internal pressure thereof and a content holding part having gas discharge lines formed above the sealing weak part.

As described above, according to the vinyl pouch for the microwave oven of the present invention including the internal pressure discharge unit having the above structure, the content holding part having gas discharge ports is formed to prevent the vinyl pouch from being exploded or deformed. In addition, even if a heating time exceeds, contents are prevented from being leaked to prevent the microwave oven from being in a mass and the contents from being disposed. In addition, the evaporation of moisture from the contents can be minimized, thereby preventing the contents from being deteriorated and losing the original taste thereof.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing one embodiment of the present invention;

FIG. 2 is a sectional view taken along line A-A′ of FIG. 1;

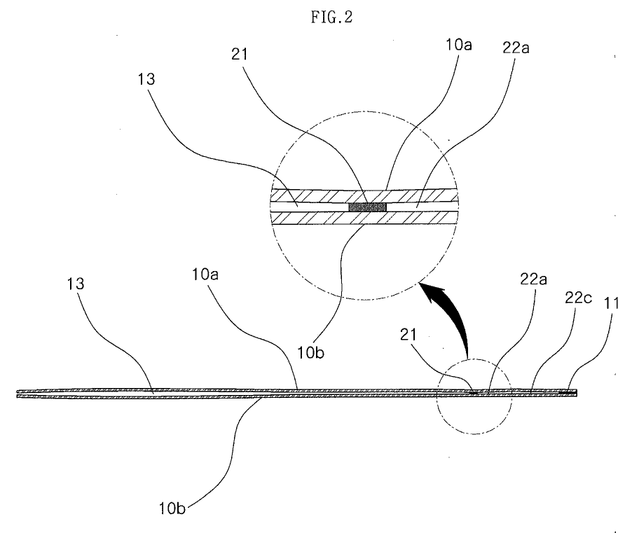

FIG. 3 is a sectional view taken along line B-B′ of FIG. 1;

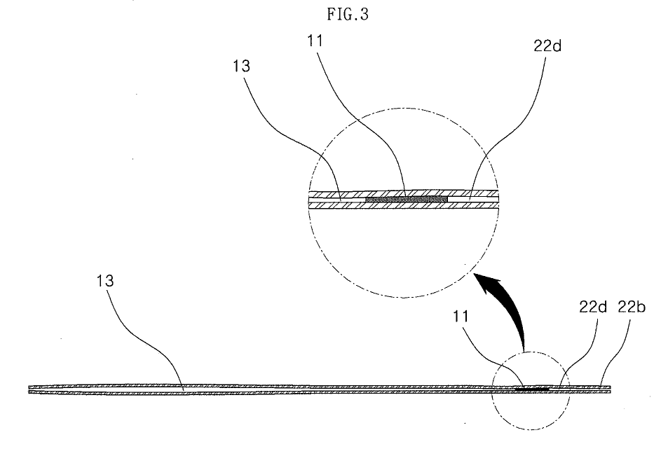

FIG. 4 is a sectional view showing the internal pressure from a vinyl pouch when contents in the vinyl pouch are heated according to the present invention;

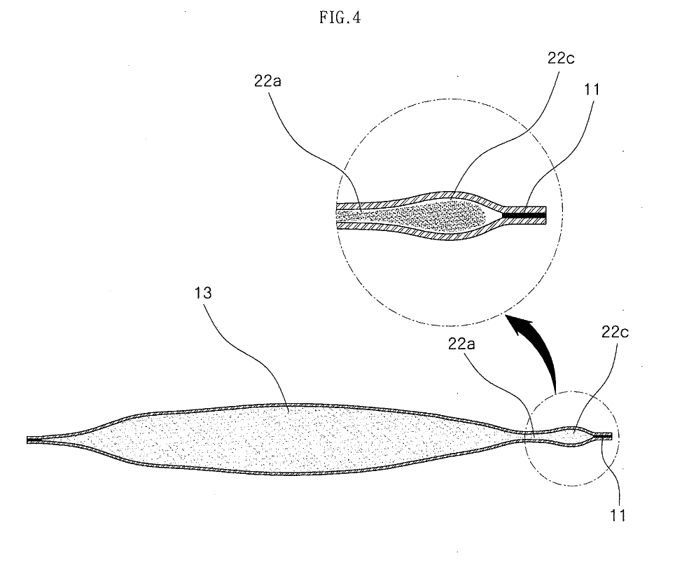

FIG. 5 is a view showing the discharge of the internal pressure of FIG. 4.

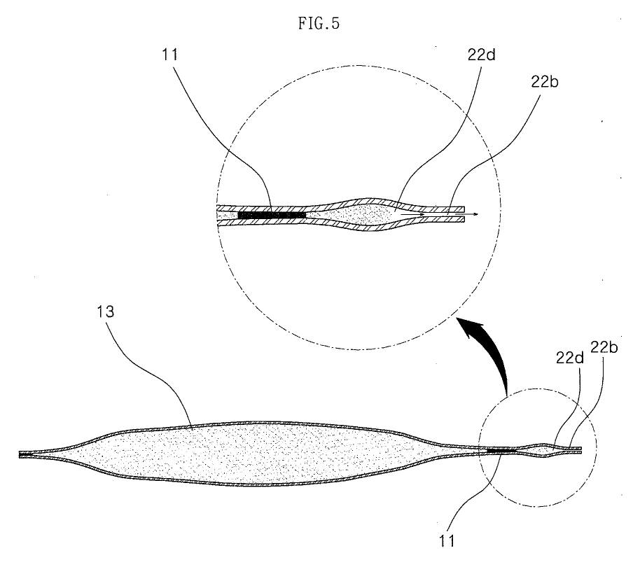

### DESCRIPTION OF THE EMBODIMENTS

Hereinafter, a preferred embodiment of the present invention will be described with reference to accompanying drawings.

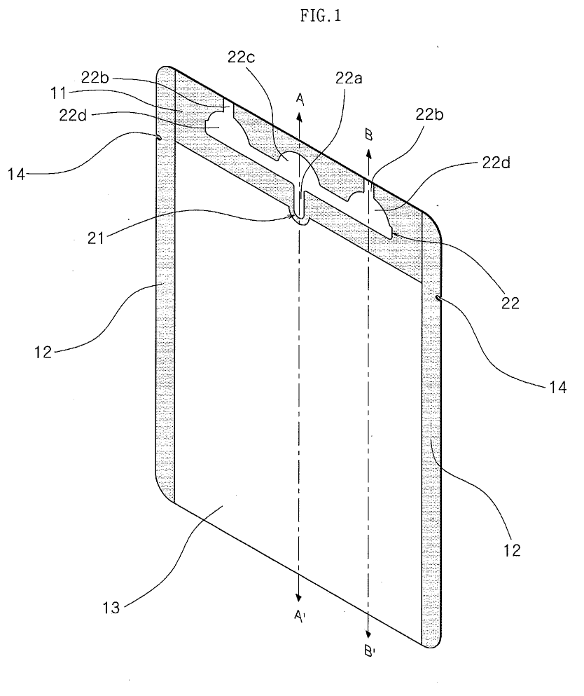

As shown in FIG. 1, a vinyl pouch usable in a microwave oven according to the present invention includes an upper sealing part 11 and side sealing parts 12 formed by sealing two vinyl sheets 10a and 10b, which face each other with the same size, at upper and side parts thereof through a thermal bonding scheme. The vinyl pouch includes a content retaining part 13 having an open lower portion inside the upper sealing part 11 and the side sealing parts 12 to receive contents. An internal pressure discharge unit is formed at the upper sealing part 11, in which the internal pressure discharge unit includes a sealing weak part 21, which is open due to the internal pressure of the content retaining part 13, and a content holding part 22, which is equipped with an introduction line 22a open when the sealing weak part 21 is open to receive gas and contents from the content retaining part 13 and gas discharge lines 22b communicating with an outer end of the upper sealing part 11.

The sealing weak part 21 is recessed at the center of an upper end of the content retaining part 13 in such a manner than the sealing weak part 21 has a semicircular shape. A lower end of the introduction line 22a of the content holding part 22 is inserted into the central portion of the sealing weak part 21. In other words, the lower end of the introduction line 22a is positioned lower than the upper end of the content retaining part 13, so that gas and contents can be smoothly fed to the content holding part 22 through the introduction line 22a simultaneously opened when the sealing weak part 21 is opened.

The content holding part 22 is open to the degree the same as the opening degree of the upper end of the content retaining part 13 such that contents are distributed to both sides of the content holding part 22, thereby minimizing gas discharge. Simultaneously, an internal pressure of the vinyl pouch can be adjusted to minimize moisture discharge from the contents.

The content holding part 22 includes an expansion part 22c upwardly protruding at the central portion thereof to prevent the gas and contents introduced into the content holding part 22 from being centralized. Expansion parts 22d similar to the expansion part 22c are additionally formed at both sides of the content holding part 22, so that the gas and contents introduced into the content holding part 22 are distributed into the both expansion parts 22d when a great amount of the gas and the contents are introduced into the content holding part 22. Accordingly, a greater amount of contents can be retained.

The expansion parts 22c and 22d upwardly protrude in a curved shape at the central portion and both sides of the content holding part 22. Accordingly, when the contents are discharged from the content holding part 22 after the contents have been heated, the contents are completely removed from the content holding part 22, so that the loss of the contents can be minimized.

In addition, the gas discharge lines 22b are formed at both sides of the content holding part 22 such that gas transferred to the content holding part 22 is retained for a long time. Accordingly, the evaporation of moisture from the contents can be minimized.

Meanwhile, the side sealing parts 12 include cutting grooves 14 formed in line with each other below the upper end of the content retaining part 13 such that the vinyl pouch can be easily open after the heating operation has been performed.

According to the vinyl pouch for the microwave oven of the present invention including the internal pressure discharge unit having the above structure, when the content retaining part 13 is expanded due to heating so that an internal pressure of the vinyl pouch must be discharged, the sealing weak part 21 is opened and the introduction line 22a of the content holding part 22 is open, so that gas and contents are transferred from the content retaining part 13 to the content holding part 22. Accordingly, the internal pressure of the vinyl pouch is primarily adjusted due to the discharge of the internal pressure from the content retaining part 13. Then, after the gas and the contents have been retained in the content holding part 22, when the internal pressure of the content holding part 22 gradually rises, so that the internal pressure must be discharged from the content holding part 22, the gas is automatically discharged through the gas discharge lines 22b. Accordingly, the internal pressure of the vinyl pouch can be secondarily adjusted.

Therefore, even if a heating time is exceeded, the discharge probability of the contents to the outside of the vinyl pouch can be reduced as much as possible. In addition, the discharge probability of even gas can be reduced as much as possible, so that the internal pressure can be maintained. Accordingly, the evaporation of moisture from the contents can be minimized.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A vinyl pouch usable in a microwave oven comprising:
an upper sealing part and side sealing parts sealed by thermal bonding;
a content retaining part having an open lower portion formed inside the upper sealing part and the side sealing parts; and
an internal pressure discharge unit which comprises a sealing weak part that is open due to an internal pressure of the content retaining part, and a content holding part formed above the sealing weak part and including an introduction line open due to opening of the sealing weak part and gas discharge lines communicating with an outer end of the content retaining part, thereby preventing contents from being discharged and dried.

2. The vinyl pouch of claim 1, wherein the sealing weak part is recessed at a central portion of an upper end of the content retaining part in such a manner than the sealing weak part has a semicircular shape, and has a central portion in which a lower end of the introduction line of the content holding part is inserted.

3. The vinyl pouch of claim 1, wherein the content holding part is open to a degree identical to an opening degree of the upper end of the content retaining part.

4. The vinyl pouch of claim 3, wherein the content holding part is provided at the central portion thereof with an upwardly protruding expansion part.

5. The vinyl pouch of claim 4, further comprising expansion parts formed at both sides of the content retaining part.

6. The vinyl pouch of claim 4, wherein the expansion parts formed at both sides of the content retaining part upwardly protrude in a curved shape.

7. The vinyl pouch of claim 1, wherein the gas discharge lines are formed at both sides of the content holding part.
